(19) United States
(12) Patent Application Publication
(10) Pub. No.: US 2004/0117827 A1
(43) Pub. Date: Jun. 17, 2004

(54) Media processing system supporting personal advertisement channel and advertisement insertion into broadcast media

(76) Inventors: Jeyhan Karaoguz, Irvine, CA (US); James Bennett, Laguna Beach, CA (US)

Correspondence Address: MCANDREWS HELD & MALLOY, LTD, 500 WEST MADISON STREET, SUITE 3400, CHICAGO, IL, 60661

(21) Appl. No.: 10/675,468

(22) Filed: Sep. 30, 2003

Related U.S. Application Data
(60) Provisional application No. 60/432,472, filed on Dec. 11, 2002.
(60) Provisional application No. 60/443,894, filed on Jan. 30, 2003.
(60) Provisional application No. 60/457,179, filed on Mar. 25, 2003.
(60) Provisional application No. 60/447,110, filed on Feb. 12, 2003.

(51) Int. Cl. G06F 13/00; H04N 5/445; G06F 3/00; H04N 7/10; H04N 7/025

(52) U.S. Cl. 725/42; 725/32; 725/36

(57) ABSTRACT

Certain embodiments of the invention for providing advertisements in a communication network may comprise receiving an advertisement on a television within a home, for example, on a personal advertisement channel. The received advertisement may be scheduled for viewing within the personal advertisement channel. Media corresponding to the received advertisement may be displayed or scheduled to be displayed on the television. Data representative of the received advertisement such as graphical data, textural data, audio data and/or video data may be presented in an available slot in a channel guide. A user profile may be provided that may contain information indicating a particular type of advertisement that is to be received. A determination may be made as to whether data representative of the particular type of advertisement is within the established profile and if so, that particular type of advertisement may be received.

### CROSS-REFERENCE TO RELATED APPLICATIONS/INCORPORATION BY REFERENCE

This application makes reference to, claims priority to, and claims the benefit of:

U.S. Provisional Application Serial No. 60/432,472 (Attorney Docket No. 14185US01 01001 P-BP-2800) filed Dec. 11, 2002;

U.S. Provisional Application Serial No. 60/443,894 (Attorney Docket No. 14274US01 01002P-BP-2801) filed Jan. 30, 2003;

U.S. Provisional Application Serial No. 60/457,179 (Attorney Docket No. 14825US01 01015P-BP-2831) filed Mar. 25, 2003; and

U.S. Provisional Application Serial No. 60/447,110 (Attorney Docket No. 14309US01 01025P-BP-2816) filed Feb. 12, 2003.

This application also makes reference to:

U.S. application Ser. No. ______ (Attorney Docket No. 14185US02 01001 P-BP-2800) filed Sep. 8, 2003;

U.S. application Ser. No. ______ (Attorney Docket No. 14274US02 01002P-BP-2801) filed Sep. 11, 2003; and

U.S. application Ser. No. ______ (Attorney Docket No. 14306US02 01013P-BP-2814) filed Sep. 30, 2003.

All of the above stated applications are incorporated herein by reference in their entirety.

### FIELD OF THE INVENTION

Certain embodiments of the invention relate to advertising over a communication network. More specifically, certain embodiments of the invention relate to a method and system for providing a personal advertisement channel and advertisement insertion into broadcast media in a media exchange network.

### BACKGROUND OF THE INVENTION

Currently, television (TV) commercials are provided by third (3^{rd}) party broadcasters independent of the person that may be viewing the commercial. Also, other forms of advertisement such as magazines are currently provided by third (3^{rd}) party advertisers independent of the person that may be reading the magazines. Consumers of various types of media content are limited to consume only those commercials or advertisements that are independently provided by the third (3^{rd}) party broadcasters and/or advertisers.

In order to reach a wide range of consumers, advertisers make various attempts at predicting, based on the type of media content, those who may be consuming the media content and, therefore, who would be more likely to view their advertisements. Based on these predictions, advertisers may target those consumers that are more likely to consume a particular type of media content that may be associated with certain types of commercials or advertisements. However, many consumers of various types of media content often ignore many commercials or advertisements because the consumers are not interested in those commercials or advertisements. Also, commercials or advertisements that are of interest to a consumer may not be viewed by a consumer since a consumer may be unavailable when the commercials or advertisements are being presented. For example, a consumer may not be watching television at the instants when a particular commercial is being broadcasted.

Certain types of sales and advertisement media are typically available only from a personal computer (PC) environment and are not accessible via television. Currently, television provides mostly fixed media that is lacking in interactivity, as may be provided by a personal computer in an Internet environment. In this regard, a television viewer may be essentially limited to watching fixed media including the same commercials that others may be watching. Accordingly, there is no opportunity to gain access to media that exists on the Internet infrastructure with a television without incorporating a personal computer functionality into the television. However, incorporating personal computer functionality into a television may result in a cumbersome user interface to the television requiring, for example, a keyboard or mouse.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention may be found in a method and system for providing an advertisement in a communication network. The method for providing an advertisement in a communication network may comprise receiving an advertisement to be displayed on a television screen within a home via, for example, a personal advertisement channel or other channel. The received advertisement may be scheduled for viewing and media corresponding to at least a portion of the received advertisement may be displayed on the television screen based on the scheduling. Data representative of the received advertisement may be presented in an available slot in a channel guide. In this regard, data representative of the received advertisement may be graphical data, textural data, audio data and/or video data.

In accordance with an embodiment of the invention, a user profile may be utilized to indicate at least a particular type of advertisement that should be received. A determination may be made as to whether data representative of the particular type of advertisement is within the established profile and if so, that particular type of advertisement may be received. Gaps or unscheduled intervals that may exist within the schedule of the channel guide may be identified and at least one advertisement may be scheduled for display at a time corresponding to the identified gap. Permission to schedule the advertisement for display within the identified gap may be requested and/or granted. A reward comprising free programming and/or reduced programming cost for scheduling the advertisement for display may be awarded.

Another embodiment of the invention may provide a machine-readable storage, having stored thereon, a computer program having at least one code section for providing an advertisement in a communication network. The at least one code section may be executable by a machine, thereby causing the machine to perform the steps as described above for providing advertisements in a communication network

Aspects of the system for providing an advertisement in a communication network may comprise at least one processor that receives the advertisement to be displayed on a television screen within a home. The advertisement may be displayed within, for example, a personal advertisement channel or other channel by the processor. The processor may be a media processing system processor, a media management system processor, a computer processor, a media exchange software processor, a media peripheral processor or a combination thereof. Notwithstanding, the received advertisement may be scheduled for viewing by the processor. Under control of the processor, media corresponding to at least a portion of the received advertisement may be displayed on the television screen based on the scheduling. Data representative of the received advertisement may be presented in an available slot in a channel guide by the processor. In this regard, data representative of the received advertisement may be graphical data, textural data, audio data and/or video data.

In an embodiment of the invention, the processor may utilize a user profile to indicate at least a particular type of advertisement that is to be received. The processor may be configured to determine whether data representative of the particular type of advertisement is within the established profile and if so, that particular type of advertisement may be received by the processor. Gaps that may exist within the schedule of the channel guide may be identified and at least one advertisement may be scheduled for display at a time corresponding to the identified gap by the processor. Permission to schedule the advertisement for display within an identified gap may also be requested and/or granted by the processor. The processor may also be adapted to offer an incentive, an award or a reward comprising free programming and/or reduced programming costs for scheduling the advertisement for display.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating an embodiment of an exemplary media exchange network 100 that may be utilized to support a personal advertisement channel and advertisement insertion into broadcast media, in accordance with various aspects of the present invention.

FIG. 1B is a diagram illustrating an embodiment of an exemplary channel view or channel guide 120, which may be associated with the media exchange network 100 of FIG. 1A and which may provide support for a personal advertisement channel and advertisement insertion into broadcast media, in accordance with various aspects of the present invention.

FIG. 2 is a flowchart illustrating a method 200 having various exemplary steps that may be utilized for pushing advertisements to the channel view or channel guide 120 of FIG. 1B in the media exchange network 100 of FIG. 1A, in accordance with various aspects of the invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a TV guide channel user interface in accordance with an embodiment of the present invention.

FIG. 7 is an exemplary illustration of several instantiations of a TV guide channel user interface of FIG. 4 in accordance with an embodiment of the present invention.

FIG. 8 is an exemplary illustration of a TV guide channel user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Certain embodiments of the present invention relate to advertising and providing a personal advertisement channel and advertisement insertion into broadcast media in a media exchange network. Certain embodiments of the invention may be also be found in a method and system for providing an advertisement in a communication network. The method for providing advertisements in a communication network may comprise receiving an advertisement within, for example, a personal advertisement channel or a regular channel to be displayed on a television screen within a home. The received advertisement may be scheduled for viewing within the personal advertisement channel. Media corresponding to the received advertisement may be displayed or scheduled to be displayed on the television screen based. Data representative of the received advertisement such as graphical data, textural data, audio data and/or video data may be presented in an available slot in a channel guide.

A user profile may be provided and may contain information that may be utilized to indicate a particular type of advertisement that is to be received. A determination may be made as to whether data representative of the particular type of advertisement is within the established profile and if so, that particular type of advertisement may be received. Gaps existing within the schedule of the channel guide may be identified and at least one advertisement may be scheduled for display at a time corresponding to the identified gap. Permission to schedule the advertisement for display within an identified gap may be requested and/or granted. A reward comprising free programming and/or reduced programming cost for scheduling the advertisement for display within the personal advertisement channel or other channel may be awarded.

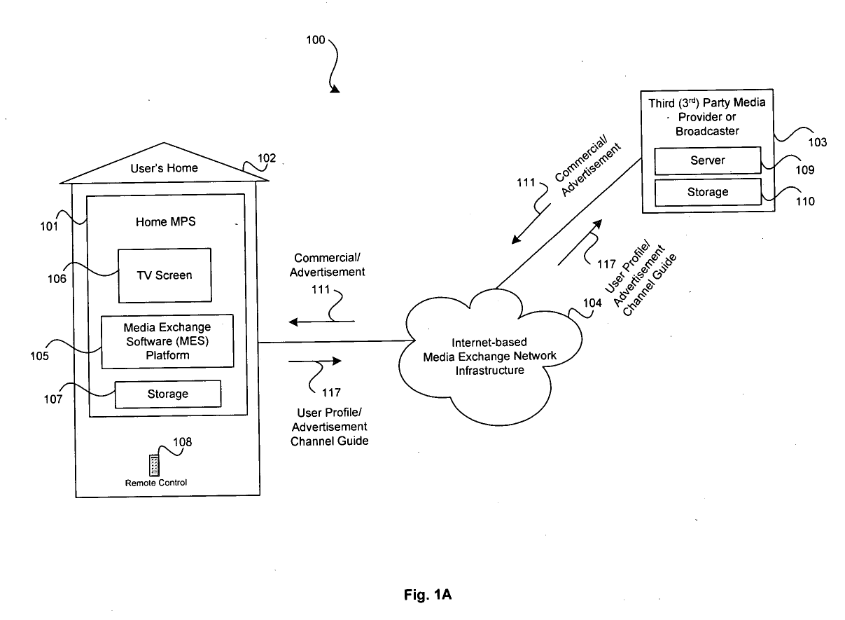

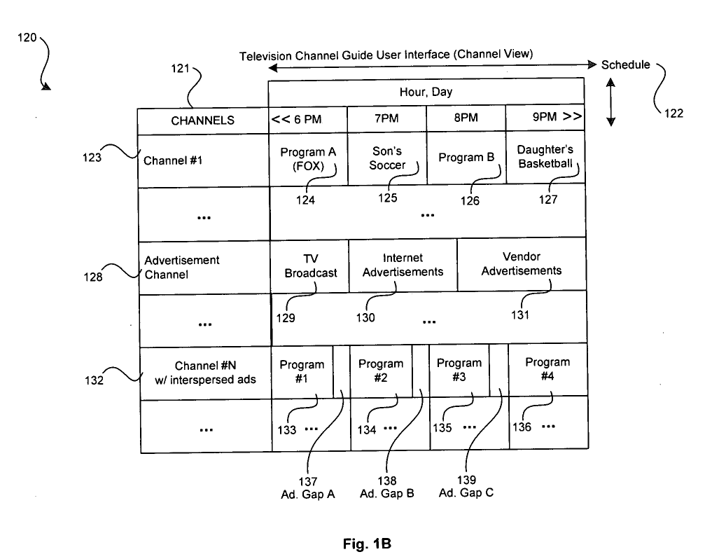

FIG. 1A is a diagram illustrating an embodiment of an exemplary media exchange network 100 that may be utilized to support a personal advertisement channel and advertisement insertion into broadcast media, in accordance with various aspects of the present invention. Referring to FIG. 1, the media exchange network 100 may include a user location which may be a user's home 102, an Internet-based media exchange network infrastructure 104 and a third (3^{rd}) party media provider or broadcaster 103. The user location or user's home 102 may include a home media processing system (MPS) 101 and a remote control 108. The Internet-based media exchange network infrastructure 104 provides connectivity between the media processing system 101 and the third (3^{rd}) party broadcaster 103. In the exemplary embodiment of FIG. 1, since the media processing system 101 is located at the user's home, it may be referred to as a home media processing system 101.

The media processing system 101 may include a media exchange software (MES) platform 105, a TV screen 106 and a storage block 107. The media exchange software platform 105 provides certain functionality within the media processing system 101, which may include, but is not limited to, the ability to receive, transfer and process broadcast media content on the media exchange network 100. The media exchange software platform 105 may also provide a channel view or channel guide that may have a television guide look-and-feel that may be displayed on a television screen or monitor. The media exchange software platform 105 may provide a user with a capability to construct a user profile and register an associated user media processing system on the media exchange network 100.

The media exchange software platform 105 may also provide a user of the media processing system 101 with the capability to control interaction with the channel view or channel guide using, for example, the remote control 108. In this regard, the remote control 108 may be adapted to receive a user input and control operations associated with supporting personal advertisement channel and advertisement in accordance with various embodiments of the invention. The remote control 108 may communicate in a wireless manner with the media processing system 101 via infrared or RF signals, in accordance with various embodiments of the invention.

Although the remote control 108 may be utilized to control at least some of the operations associated with supporting personal advertisement channel and advertisement insertion of the media processing system 101, the invention is not so limited. Accordingly, the user may utilize other devices that may function as I/O devices and/or navigational tools to control the operations associated with supporting personal advertisement channel and advertisement insertion associated with the media processing system 101. For example, a mouse, a touch-screen television or monitor display, and/or a keyboard may be utilized to control the operations associated with the support of personal advertisement channel and advertisement insertion associated with the media processing system 101 such as to manage a user profile or channel guide. In accordance with another aspect of the invention, a special code reading device may be utilized to scan, read and/or interpret various information that may be associated with the operation and support of personal advertisement channel and advertisement insertion that may be displayed on the television screen 106. The special code reading device may also have the capability to scan information that may be associated with the operation and support of personal advertisement channel and advertisement insertion that may be found in print media including, but not limited to, magazines, newspapers, books and charts. The special code reading device may further be utilized to establish and/or modify a user profile.

A media processing system may also comprise a set-top-box (STB), a PC, and/or a television with a media management system (MMS). A media management system may also be referred to as a media exchange software (MES) platform. Notwithstanding, a media management system may include a software platform operating on at least one processor that may provide certain functionality including user interface functionality, distributed storage functionality, networking functionality, and automatic control and monitoring of media peripheral devices. For example, a media management system may provide automatic control of media peripheral devices, automatic status monitoring of media peripheral devices, and inter-home media processing system routing selection. A media processing system may also be referred to as a media-box and/or an M-box. Any personal computer may indirectly access and/or control any media peripheral device in instances where the personal computer may include a media management system. Such access and/or control may be accomplished through various communication pathways via the MPS or outside of the media processing system. A media processing system may also have the capability to automatically access and control any media peripheral device without user interaction and/or with user intervention. A personal computer (PC) may include media exchange software running on or being executed by the personal computer and may be referred to as a media processing system. The media processing system may also include a speech recognition engine that may be adapted to receive input speech and utilize the input speech to control various functions of the media processing system.

Each of the elements or components of the network for communicating media or media exchange network may be identified by a network protocol address or other identifier which may include, but is not limited to, an Internet protocol (IP) address, a media access control (MAC) address and an electronic serial number (ESN). Examples of elements or components that may be identified by such addresses or identifiers may include media processing systems, media management systems, personal computers, media or content providers, media exchange software platforms and media peripherals.

The communication infrastructure 105 may include cable infrastructure, xDSL infrastructure, satellite network infrastructure, Internet infrastructure, intranet infrastructure or other similar access and/or transport infrastructure. In this regard, the Internet-based media exchange network infrastructure 104 may provide access and/or transport functionality that may facilitate the exchange of media between, for example, the user's home 102 and the third (3^{rd}) party broadcaster or provider 103. The intranet infrastructure which may be part of the Internet-based media exchange network infrastructure may also be adapted to providing wide area network (WAN) capability. The exchange of media may be utilized to support personal advertisement channels and advertisement insertion in accordance with various embodiments of the invention.

The third (3^{rd}) party media provider or broadcaster 103 may supply third (3^{rd}) party media content to user locations such as the user's home 102 via the Internetbased media exchange network infrastructure. The third (3^{rd}) party media provider or broadcaster 103 may be a television broadcaster, a portal, a radio broadcaster, an advertisement company, an Internet service provider (ISP) any of which may provide media content in a digital format. The third (3^{rd}) party media provider or broadcaster 103 may include a server 109 and a storage block 110. Media content supplied by the third (3^{rd}) party provider 103 may comprise commercials or advertisements in video, audio and/or textural formats. In general, the third (3^{rd}) party media provider or broadcaster 103 may transfer media content over the media exchange network 100 and receive responses and/or requests from users and/or subscribers via the media exchange network 100.

The server 109 may be, for example, a file-based server and may be implemented as part of or an adjunct to a personal computer (PC) and/or a mainframe computer system. Notwithstanding, the server 109 may have the capability to push broadcast media content that is stored in the storage block 110 to the media processing system 101 via the Internet-based media exchange network infrastructure 104. In accordance with an aspect of the invention, the server 109 may also be configured to provide commercials or advertisements 111 to user's of the media exchange network 100.

The storage block 110 may be utilized to store media content provided by the (3^{rd}) party media provider or broadcaster 103. The storage block 110 may include, but is not limited to, a database, a CD tower, a jukebox, a magnetic disk, an optical disk, a magneto-optical disk, a solid state memory device, a tape device, a media peripheral, a server, a media processing system and a computer having various memory and/or storage devices.

The media processing system 101 may have the capability to receive the broadcast media including advertisements and commercials 111 and select one or more functions associated with a user profile, advertisement channel or commercial channel guide 117, in accordance with various embodiments of the invention. The television screen 106 of the media processing system 101 may provide a user with the capability to view broadcast media content including, but not limited to, advertisements or commercials 111. Accordingly, notifications or other information that may be associated with personal advertisement channels and advertisement insertion may be displayed on the television screen 106 of media processing system 101. The notification may be automatically displayed or it may be displayed based on user interaction. For example, the user interaction may include the pushing of a button on the remote control 108 by a user of the media processing system 101. In this regard, the user may choose when to view the notification and may even decide what types of notification should be received and when they should be received. Based on the notifications, appropriate modifications such as deletions or additions may be made to the user profile.

In accordance with an embodiment of the invention, the information that may be associated with personal advertisement channels and advertisement insertion may be provided by the third (3^{rd}) party broadcaster 103 along with a broadcasted media. The information that may be associated with personal advertisement channels and advertisement insertion may include at least one media exchange function that may be selectable by a user via a channel guide interface, for example. In other words, while a user's media processing system may be displaying an audio, video and/or data representation of a real-time media broadcast, a media exchange function related to the media broadcast and personal advertisement channel and advertisement insertion may be made available to the user, either automatically or through user interaction. In any case, upon selection by a user, media content may be communicated from the third (3^{rd}) party media provider or broadcaster to the user or subscriber. In this regard, the media content associated with the selected media exchange function and information that may be associated with personal advertisement channels and advertisement insertion may be transferred from the third (3^{rd}) party media provider or broadcaster to the user subsequent to the user selection.

U.S. application Ser. No. ______ (Attorney Docket No. 14285US02) filed on Sep. 30, 2003 illustrates various aspects of an exemplary channel view or channel that may be utilized in connection with invention and is hereby incorporated herein by reference in its entirety.

FIG. 1B is a diagram illustrating an embodiment of an exemplary channel view or channel guide 120, which may be associated with the media exchange network 100 of FIG. 1A and which may provide support for a personal advertisement channel and advertisement insertion into broadcast media, in accordance with various aspects of the present invention. Referring to FIG. 1B, the channel view or media guide 120 may comprise a table of media channels 121 versus scheduled media content 122. For example, the media channels 121 may comprise a plurality of channels including a “channel #1” 123, a personal advertisement channel 128, and a “channel #N” 132, each of which are set up or established by the user of the media processing system 101. The channel view or channel guide 120 may exist within the media processing system 101 and may be adapted to provide personal channel selections to a user of the media processing system 101.

The “channel #1” 123 may include media content comprising a “program A” 124, a “son's soccer game” 125, a “program B” 126, and a “daughter's basketball game” 127. The “program A” 124 and the “Program B” 126 may comprise television broadcast programs, for example. The personal advertisement channel 128 may include available time slots for media content comprising “TV broadcast commercials” 129, “Internet ads” 130, and “vendor ads” 131 that may be pushed or otherwise communicated from the third (3^{rd}) party provider 103 to the media processing system 101 on the media exchange network 100.

The “channel #N” 132 may include media content comprising a “program #1” 133, an “ad gap A” 137, a “program #2” 134, an “ad gap B” 138, a “program #3” 135, an “ad gap C” 139, and a “program #4” 136. The programs 133, 134, 135, and 136 may comprise scheduled television broadcast programs that may have been personally scheduled by the user of media processing system 101. The advertisement gaps (ad gaps) 137, 138, and 139 are time gaps, slots or intervals that may appear between the scheduled programs in the “channel #N” 132. The advertisement gaps 137, 138, and 139 are available time slots in the channel view or channel guide 120 where commercials or advertisements may be pushed in the channel view or channel guide 120 by the (3^{rd}) party provider 103.

In accordance with an embodiment of the present invention, the user of the media processing system 101 may create a user profile that may identify interests and consumer habits of the user. As a result, the third (3^{rd}) party provider 103 may utilize the user profile to determine specific commercials or advertisements that are to be pushed or be otherwise transferred to the channel view or channel guide 120 of the media processing system 101. The user profile may be changed or modified by the user or may be changed by a third (3^{rd}) party provider based on inferences that may be made by the third (3^{rd}) party provider based on, for example, a history of user viewing and/or user purchasing habits. In another aspect of the invention, a default user profile may be provided, which may be modified by either the user and/or the third (3^{rd}) party provider. In an aspect of the invention, the user profile may reside in the media processing system 101 and may be accessible by both the third (3^{rd}) party provider 103 and the media processing system. Notwithstanding, the user profile may reside in the third (3^{rd}) party provider 103, having already been pushed or otherwise transferred to the third (3^{rd}) party provider 103 by the media processing system 101.

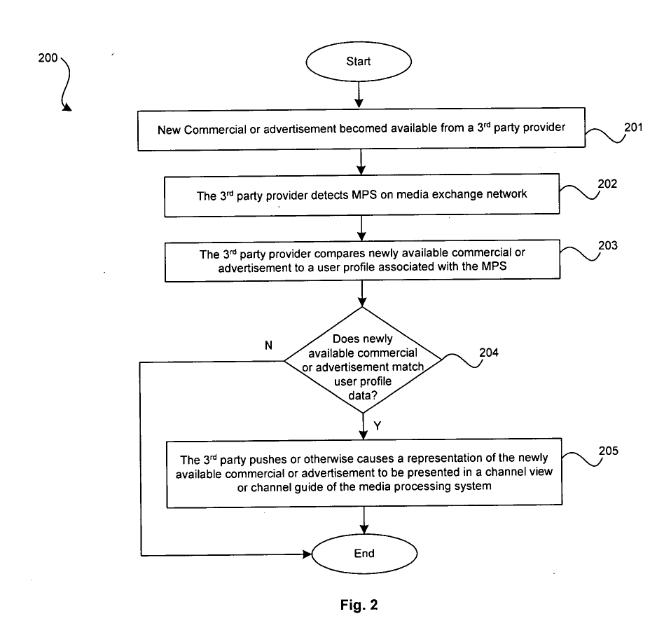

FIG. 2 is a flowchart illustrating a method 200 having various exemplary steps that may be utilized for pushing advertisements to the channel view or channel guide 120 of FIG. 1B in the media exchange network 100 of FIG. 1A, in accordance with various aspects of the invention. In step 201, a new commercial or advertisement becomes available from a third (3^{rd}) party provider on a media exchange network. In step 202, the third (3^{rd}) party provider detects a media processing system on the media exchange network. In step 203, the third (3^{rd}) party provider compares the newly available commercial or advertisement to a user profile of the media processing system. In step 204, a decision is made as to whether or not the newly available commercial or advertisement matches data that may be contained in the user profile. If the newly available commercial or advertisement does match the data that may be in the user profile, then in step 205, the third (3^{rd}) party provider may push or otherwise cause information representing the newly available commercial or advertisement to be presented in a channel view or channel guide of the media processing system on the media exchange network.

In an illustrative embodiment of the invention, a user of the media processing system 101 may set up a user profile indicating an interest in foreign cars and authorizing at least one selected third (3^{rd}) party provider on the media exchange network 100 to push or otherwise transfer commercials or advertisements associated with foreign car to the advertisement channel 128 of the channel view or channel guide 120. A television broadcaster such as the third (3^{rd}) party provider 103 may detect the presence of the media processing system 101 on the media exchange network 100 and access a user profile 117 on the media processing system 101 via the media exchange network 100. The television broadcaster may process the user profile 117 and match the user's interest in foreign cars with a newly available foreign car commercial 111. The television broadcaster may then access the schedule 117 of the advertisement channel 128 and schedule the newly available foreign car commercial 111 under the time slot of “TV broadcast commercials” 129. The television broadcaster such as the third (3^{rd}) party provider 103 may then push or otherwise communicate or transfer the newly available foreign car commercial 111 to the media processing system 101. Accordingly, information representative of the foreign car commercial may be presented or stored in the channel view or channel guide 120 in the advertisement channel 128 under the time slot of “TV broadcast commercials” 129. As a result, the next time the user of the media processing system 101 accesses the channel view or channel guide 120, the newly available foreign car commercial 111 scheduled under the time slot for “TV broadcast commercials” 129 is presented and the scheduled foreign car commercial 111 may be viewed.

In accordance with an embodiment of the invention, the pushing or otherwise transfer of a commercial or advertisement from a third (3^{rd}) party provider may be done in non-real-time. For example, a user may have the capability to specify that commercials or advertisements are only to be pushed to a particular media processing system such as media processing system 101 overnight, thereby taking advantage of a lowest cost option for receiving the commercials or advertisements. Similarly, other third (3^{rd}) party providers may push Internet advertisements to the time slot of “Internet ads” 130 in the advertisement channel 128, or push vendor ads to the time slot of “vendor ads” 131 in the advertisement channel 128. An Internet advertisement may originate at, for example, an Internet service provider on the media exchange network 100. A vendor advertisement may originate at a web site of a particular vendor, for example, a manufacturer of digital cameras.

In accordance with another embodiment of the invention, commercials or advertisements may be pushed or otherwise transferred by third (3^{rd}) party providers to fill gaps between a scheduled channel programming. Data representative of these commercials may be presented in “channel N” 132 of channel view or channel guide 120. For example, the television broadcaster with the newly available foreign car commercial 111, after having processed the user profile 117 of the media processing system 101, may scan the channel view or channel guide 120 looking for available time gaps between scheduled programming in various channels. Accordingly, the television broadcaster may determine that “ad gap A” 137 is large enough to fit the foreign car commercial and data representative of the foreign car commercial may be inserted or presented in the “ad gap A” 137 of the “channel #N” 132. As a result, when the user of the 101 completes viewing “program #1” 133, the inserted foreign car commercial in “ad gap A” 137 may be played next. In a similar manner, other commercials or advertisements may be inserted into “ad gap B” 138 and “ad gap C” 139 and the channel view or channel guide may be updated accordingly.

Media provided by a third party broadcaster may be queued for viewing. In this regard, if downloading of broadcast media from a first third (3^{rd}) party provider is delayed because the broadcast media is being queued to a certain time slot in a channel, a second 3^{rd} party provider could push commercials or advertisements into the same time slot until queuing of the broadcast media is completed. This may occur if the time slot is sufficient to accommodate the pushed commercials or advertisements. Notwithstanding, a length of the pushed commercials or advertisements may be reduced to fit into the time slot.

In accordance with other embodiments of the invention, although the push or otherwise transfer of commercials or advertisements to the media processing system 101 by third (3^{rd}) party providers may be based on a user profile, the invention is not so limited. Accordingly, the push or otherwise transfer of the commercials or advertisements may be based on, for example, user inputs to the media processing system 101 during viewing, specific user requests to third (3^{rd}) party providers, or specific user pre-selections made on a web site by the user of media processing system 101. A user may also be provided with a capability to filter out certain types of commercials or advertisements from being pushed to a particular media processing system such as media processing system 101, independent of a particular user profile. For example, a user having a preference for foreign cars, may not want to view foreign car commercials of Korean cars.

In another aspect of the invention, the media processing system 101 may provide feedback information to the third (3^{rd}) party provider 103 over the media exchange network. For example, the media processing system 101 may alert the third (3^{rd}) party provider 103 when the user has viewed a commercial that was previously pushed to the media processing system 101 by the third (3^{rd}) party provider 103. Accordingly, with this knowledge, the third (3^{rd}) party provider 103 may send a different commercial that may replace the first commercial. The third (3^{rd}) party provider 103 may also provide special perks or incentives to the user of a media processing system 101 for taking the time to view the commercials or advertisements that were pushed or otherwise transferred by the third (3^{rd}) party provider 103 to the user. For example, the third (3^{rd}) party provider 103 may allow the user to download a free movie to the media processing system 101 from the third (3^{rd}) party provider 103 for every 50 commercials the user views from the third (3^{rd}) party provider 103.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, settop-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

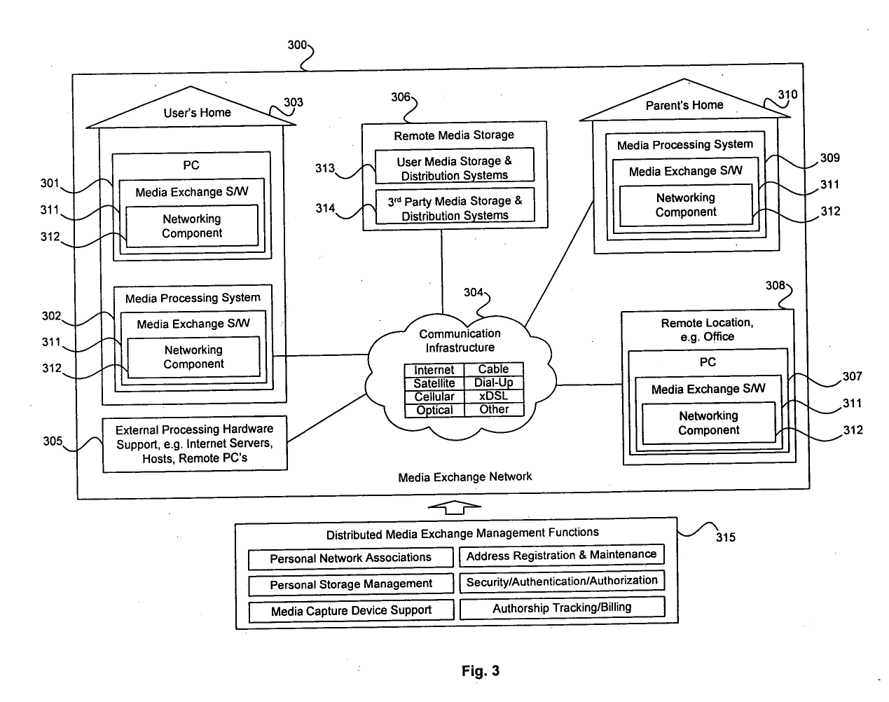

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, interhome routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, xDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

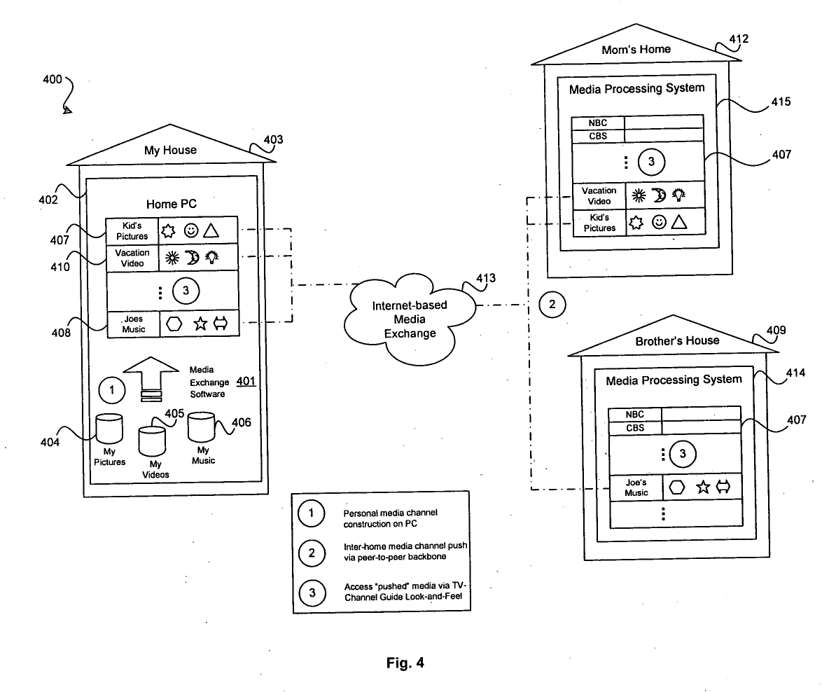

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

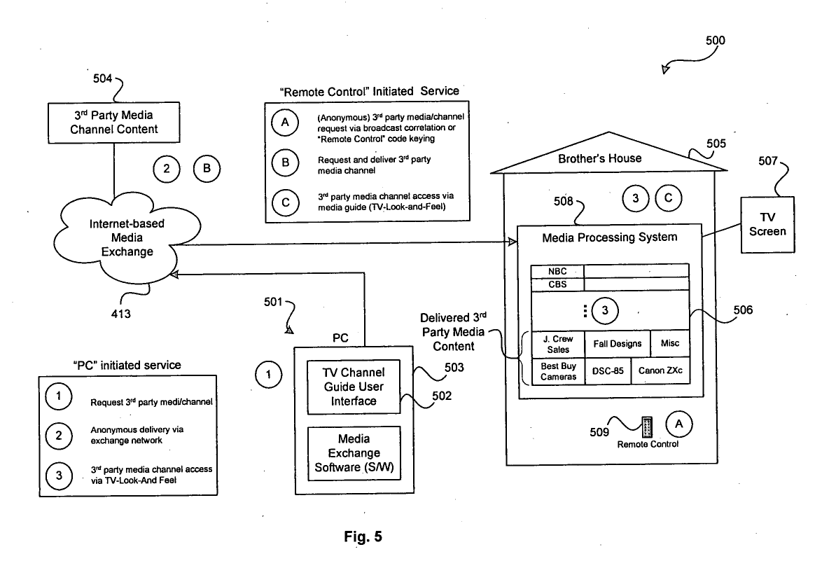

FIG. 5 illustrates an example of third-party media exchange over a media exchange network 500 in accordance with an embodiment of the present invention. In step 1, a PC-initiated third-party request is made by a first party 501 via an internetbased media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

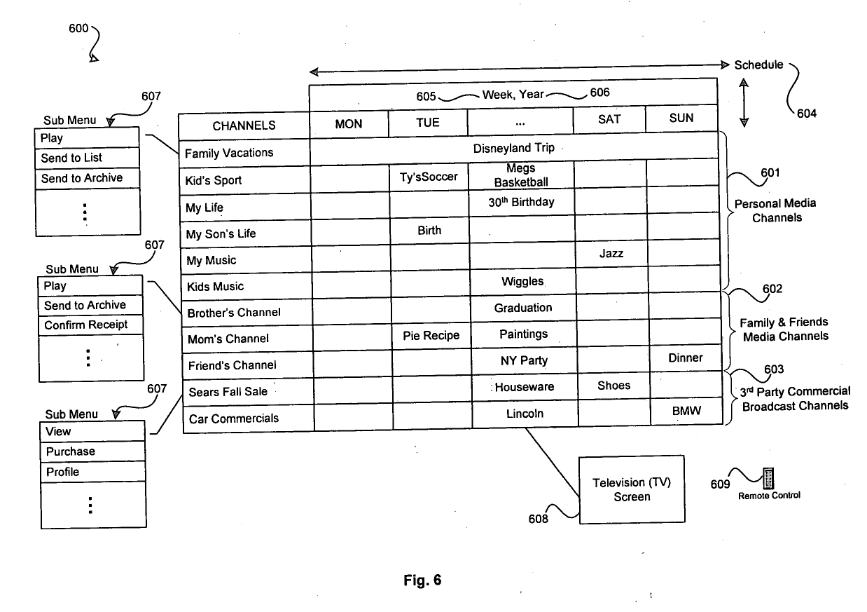

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

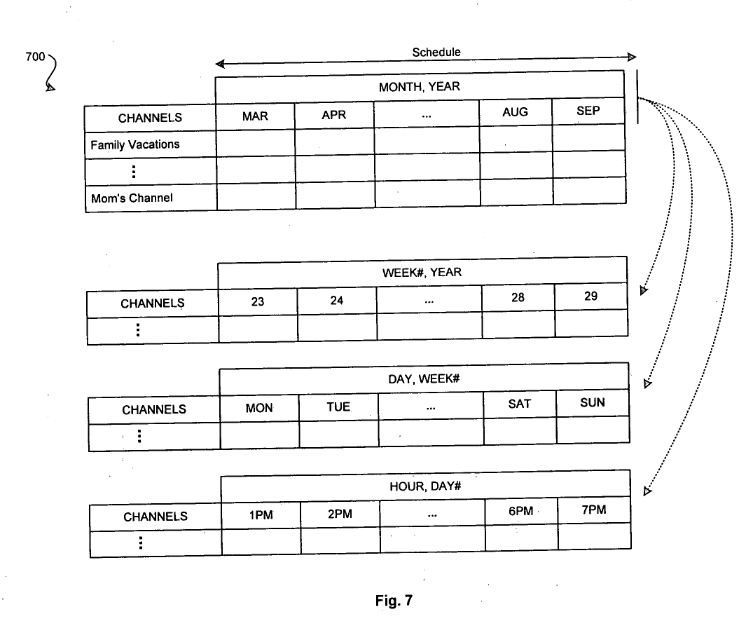

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

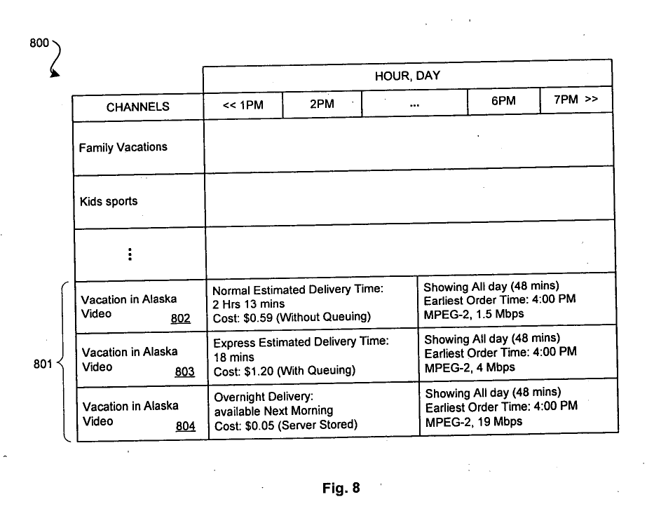

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

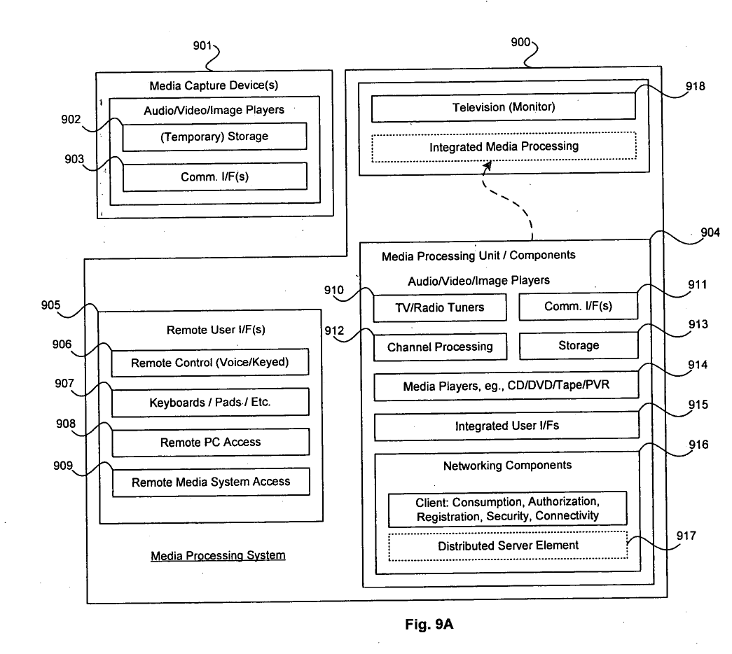

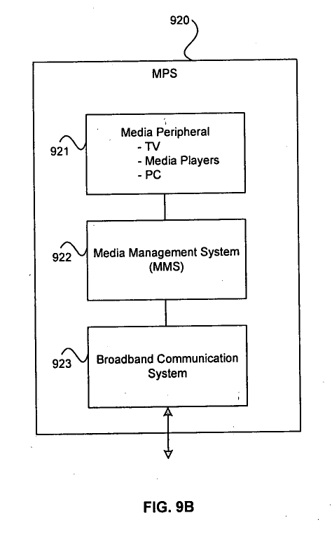

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

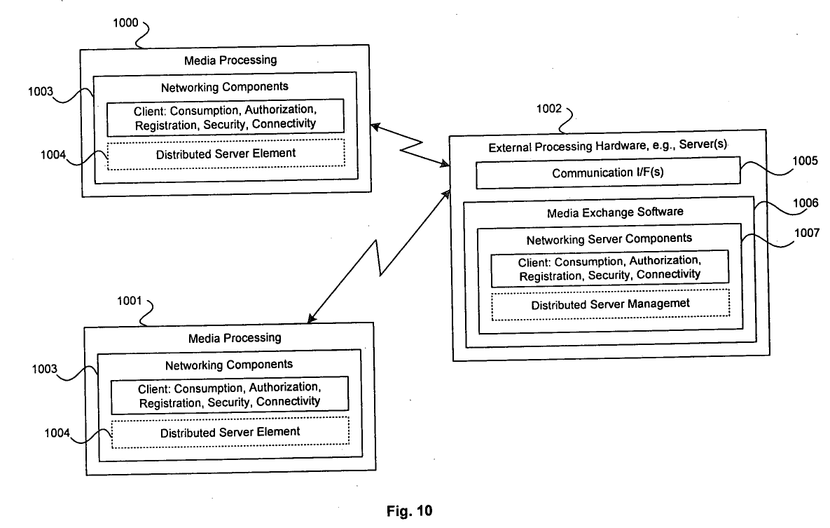

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

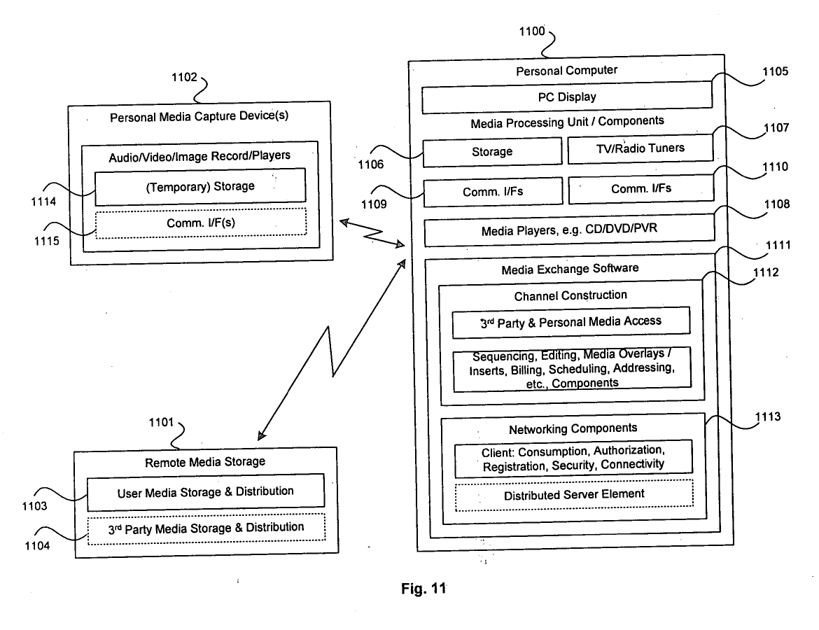

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

Aspects of the system for providing an advertisement in a communication network may also comprise at least one processor that receives the advertisement within, for example, a personal advertisement channel or other channel to be displayed on a television screen within a home. The processor may schedule the received advertisement for viewing by the processor. Under control of the processor, media corresponding to at least a portion of the received advertisement may be displayed on the television screen based on the scheduling. Data representative of the received advertisement, which may include but is not limited to, graphical data, textural data, audio data and/or video data, may be presented in an available slot in a channel guide by the processor.

The processor may utilize a user profile to indicate at least a particular type of advertisement that is to be received. The processor may also be configured to determine whether data representative of the particular type of advertisement is within the established profile. If data representative of the particular type of advertisement is within the established profile, then that particular type of advertisement may be received by the processor and displayed on the television screen within the home. Gaps that may exist within the schedule of the channel guide may be identified and one or more advertisements may be scheduled for display at a time corresponding to the identified gap by the processor. Permission to schedule the advertisement for display within identified gap may also be requested and/or granted by the processor. The processor may also be adapted to offer an incentive, award or reward comprising free programming and/or reduced programming costs for scheduling the advertisement for display within the personal advertisement channel or other channel.

Accordingly, the present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for providing an advertisement in a communication channel, the method comprising:
receiving the advertisement for display on a television within a home;
scheduling said received advertisement for viewing on said television within said home; and
displaying media corresponding to at least a portion of said scheduled advertisement on said television based on said scheduling.

2. The method according to claim 1, further comprising presenting data representative of said received advertisement in an available slot in a channel guide.

3. The method according to claim 2, wherein said data representative of said received advertisement is at least one of graphical data, textural data, audio data and video data.

4. The method according to claim 1, further comprising establishing a user profile indicating at least a particular type of advertisement that is to be received.

5. The method according to claim 4, further comprising:
determining whether data representative of said particular type of advertisement is within said established profile; and
if said data representative of said particular type of advertisement is within said established profile, receiving said particular type of advertisement.

6. The method according to claim 1, further comprising identifying a gap that exists in a schedule in a channel guide displayed on said television.

7. The method according to claim 6, further comprising scheduling at least one advertisement for display at a time corresponding to said identified gap.

8. The method according to claim 6, further comprising granting permission to schedule said at least one advertisement for display within said identified gap.

9. The method according to claim 1, further comprising offering a reward for scheduling the advertisement for display within a personal advertisement channel displayed on said television.

10. The method according to claim 9, wherein said reward further comprises at least one of free programming and reduced programming cost.

11. A machine-readable storage having stored thereon, a computer program having at least one code section for providing an advertisement in a communication network, the at least one code section being executable by a machine for causing the machine to perform steps comprising:
receiving the advertisement for display on a television within a home;
scheduling said received advertisement for viewing on said television within said home; and
displaying media corresponding to at least a portion of said scheduled advertisement on said television based on said scheduling.

12. The machine-readable storage according to claim 11, further comprising code for presenting data representative of said received advertisement in an available slot in a channel guide.

13. The machine-readable storage according to claim 12, wherein said data representative of said received advertisement is at least one of graphical data, textural data, audio data and video data.

14. The machine-readable storage according to claim 11, further comprising code for establishing a user profile indicating at least a particular type of advertisement that is to be received.

15. The machine-readable storage according to claim 14, further comprising:
code for determining whether data representative of said particular type of advertisement is within said established profile; and
code for receiving said particular type of advertisement if said data representative of said particular type of advertisement is within said established profile.

16. The machine-readable storage according to claim 11, further comprising code for identifying a gap that exists in a schedule in a channel guide displayed on said television.

17. The machine-readable storage according to claim 16, further comprising code for scheduling at least one advertisement for display at a time corresponding to said identified gap.

18. The machine-readable storage according to claim 16, further comprising code for granting permission to schedule said at least one advertisement for display within said identified gap.

19. The machine-readable storage according to claim 11, further comprising code for offering a reward for scheduling the advertisement for display within a personal advertisement channel displayed on said television.

20. The machine-readable storage according to claim 19, wherein said reward further comprises at least one of free programming and reduced programming cost.

21. A system for providing an advertisement in a communication network, the system comprising:
at least one processor that receives the advertisement for display on a television within a home;
said at least one processor that schedules said received advertisement for viewing on said television within said home; and
said at least one processor that causes media corresponding to at least a portion of said scheduled advertisement to be displayed on said television based on said scheduling.

22. The system according to claim 21, wherein said at least one processor presents data representative of said received advertisement in an available slot in a channel guide.

23. The system according to claim 22, wherein said data representative of said received advertisement is at least one of graphical data, textural data, audio data and video data.

24. The system according to claim 21, wherein said at least one processor establishes a user profile indicating at least a particular type of advertisement that is to be received.

25. The system according to claim 24, wherein said at least one processor:
determines whether data representative of said particular type of advertisement is within said established profile; and
receives said particular type of advertisement if said data representative of said particular type of advertisement is within said established profile.

26. The system according to claim 21, wherein said at least one processor identifies a gap that exists in a schedule in a channel guide displayed on said television.

27. The system according to claim 26, wherein said at least one processor schedules at least one advertisement for display at a time corresponding to said identified gap.

28. The system according to claim 26, wherein said at least one processor grants permission to schedule said at least one advertisement for display within said identified gap.

29. The system according to claim 21, wherein said at least one processor offers a reward for scheduling the advertisement for display within a personal advertisement channel displayed on said television.

30. The system according to claim 29, wherein said reward further comprises at least one of free programming and reduced programming cost.

31. The system according to claim 21, wherein said at least one processor is at least one of a media processing system processor, a media management system processor, a computer processor, media exchange software processor and a media peripheral processor.
